(19) United States
(12) Patent Application Publication
(10) Pub. No.: US 2009/0013016 A1
(43) Pub. Date: Jan. 8, 2009

(54) SYSTEM AND METHOD FOR PROCESSING DATA FOR DATA SECURITY

(75) Inventors: Landon Curt Noll, Sunnyvale, CA (US); Charles Adley LeBlanc, San Jose, CA (US)

Correspondence Address: FISH & RICHARDSON P.C., PO BOX 1022, MINNEAPOLIS, MN, 55440-1022, US

(73) Assignee: NeoScale Systems, Inc., Milpitas, CA (US)

(21) Appl. No.: 11/774,521

(22) Filed: Jul. 6, 2007

(51) Int. Cl. G06F 12/00

(52) U.S. Cl. 707/205; 707/E17.01

(57) ABSTRACT

System and method for processing data for data security. A method for encrypting a data file includes a step for providing an input file, which can be characterized by an input length, and providing a number of output files that include a first output file and a second output file. The first output is characterized by a first output length. The first output length is associated with the input length and the number of output files. The first output file includes a header section and a data section. The header section includes information associated with the number. In addition, the method includes a step for determining a first location and a second location of the input file. The second location is behind the first location by a known length.

### BACKGROUND OF THE INVENTION

The present invention relates generally to data security and storage, and more particularly to techniques for storing an input data file as two or more encrypted output data files.

With the advent of the information technology, more and more information is stored electronically. To protect electronically stored information, various conventional techniques have been developed. Besides protecting hardware storage equipment (i.e., hard disk, tape, compact disc, etc.), data backup and archive have been a popular and reliable way for protecting stored information.

Data backup in general refers to making copies of data and storing these copies. When the original data are lost or destroyed, information from the original data is recovered from these copies. To further ensure the safety of data, data that is stored in a storage device is first encrypted and then the encrypted data is stored at a different storage device (i.e., a different hard drive). In the past, various conventional techniques have been developed for performing data encryption and storage. Unfortunately, these conventional techniques are often inadequate.

Conventional techniques for encrypting and storing data have been inadequate in light of recent developments in information technology, where file size becomes larger and larger. More specifically, encrypting and storing large data files using conventional techniques are often too slow and inefficient.

According to various conventional techniques, the process of securely storing data file involves reading an input data file, encrypting the input data file, and finally storing the encrypted input data file as an output file. Typically, the entire process is performed by one thread in a sequential order. For example, the same thread reads the entire input data file. As a result, the speed of the process is limited by the speed which the thread reads the input file. Essentially, the entire process cannot be faster than its slowest step, which in this case is usually reading the file. When the size of the input data file is small, the speed of the process is typically acceptable. However, when the input data file size is large (e.g., over one gigabyte), the speed of the process is often too low for many applications.

Therefore, it is desirable to have improved system and method for encrypting and storing data.

### BRIEF SUMMARY OF THE INVENTION

Embodiments of the present invention provide a method and system for storing an input data file as two or more encrypted output data files, which can later be decrypted and combined to form a file that is identical to the input data file. More particularly, embodiments of the present invention allow a single input data file to be processed by multiple threads in parallel and multiple encrypted output files to be stored in different locations. Among other things, embodiments of the present provide a more efficient method for storing encrypted data as compared to conventional methods. Merely by way of example, the present invention has been used to provide a secured backup solution for large files, but it would be recognized that the invention has a much broader range of applicability.

According to an embodiment, the present invention provides a method for encrypting a data file. The method includes a step for providing an input file, which can be characterized by an input length. The method also includes a step for providing a number of output files that include a first output file and a second output file. The first output is characterized by a first output length. The first output length is associated with the input length and the number of output files. The first output file includes a header section and a data section. In an exemplary embodiment, the header section includes information associated with the number. In addition, the method includes a step for determining a first location and a second location of the input file. The second location is behind the first location by a known length. The method also includes a step for obtaining a first data segment from reading the input file at the first location by a first thread for the known length. The method further includes a step for obtaining a second data segment from reading the input file at the second location by a second thread. Moreover, the method includes a step for encrypting the first data segment. Furthermore, the method includes a step for storing the encrypted first data segment at the data section of the first output file.

According to another embodiment, the present invention provides a method for encrypting a data file. The method includes a step for providing an input file that has an input length. The method also includes a step for providing a number of output files. The output files includes a first output file and a second output file. The first output file is characterized by a first output length, which is associated the input length and the number of output files. The first output file includes a first plurality of blocks, which includes a first block and a second block. The first block and the second block are characterized by the same block size. Each of the first plurality of blocks includes a header section and a data section. The header section includes information with the number. The method further includes a step for determining a first location and a second location of the input file. The second location is behind the first location by a known length. The method also includes a step for obtaining a first data segment from reading the input file at the first location by a first thread for the known length. The method additionally includes a step for obtaining a second data segment from reading the input file at the second location by a second thread. Additionally, the method includes a step for encrypting the first data segment. Moreover, the method includes a step for storing the encrypted first data segment at the first block.

According to yet another embodiment, the present invention provides a method for decrypting data. The method includes a step for identifying a plurality of input data files. The plurality of input data files includes a first input data file and a second data file. Each of input data files is associated with an output data file. The method also includes a step for processing the first input data file. The method further includes a step for obtaining information associated with the output data file from the first input data file. Among other things, the information includes a block size. The method additionally includes a step for determining two adjacent blocks at the first input data file. The two adjacent blocks includes a first block and a second block. In addition, the method includes a step for determining two adjacent blocks at the second input data file. The two adjacent blocks includes a third block. The method also includes a step for obtaining a first data segment by decrypting the first block. Moreover, the method includes a step for obtaining a second data segment by decrypting the third block. Also, the method includes a step for storing the first data segment and second data segment in a continuous portion of the output data file.

According to yet another embodiment, the present invention provides a system for storing data. The system includes a first storage device that is configured to store an input file. The input file includes a first section and a second section. The system also includes a second storage device that is configured to store a plurality of data files. The plurality of data files includes a first output file and a second output file. The file output file and the second output file have the same length. The system additionally includes a first access component that is configured to access the first storage device. The system also includes a second access component that is configured to access the first storage device. Moreover, the system includes a processor component that is configured to provide a first thread and a second thread. The first access component reads data from the first section. The first thread generates a first output data by encrypting the first section. The second access component reads data from the second section. The second thread generates a second output data by encrypting the second section. The second storage device stores the first output data at the first output file and the second output data at the second output file.

It is to be appreciated that the present invention provides various advantages over conventional techniques. Among other things, threading operating according to embodiments of the present invention allows quicker data access and encryption compared to conventional techniques, as operations are performed in parallel. More specifically, embodiments of the present invention are particularly suitable for encryption of large files (e.g., binary backups of files larger than 10 GB). According to various embodiments, since a file is broken down to separate encrypted files during the encryption operation, a system administrator is able to store the encrypted files at to multiple different locations for additional security. There are other advantages as well.

Various additional objects, features and advantages of the present invention can be more fully appreciated with reference to the detailed description and the accompanying drawings that follow.

### BRIEF DESCRIPTION OF THE DRAWINGS

FIG. 1 is a simplified diagram illustrating a computer system that is utilized to implement an embodiment of the present invention;

FIG. 2 is a simplified diagram illustrating an encryption operation according to an embodiment of the present invention;

FIG. 3 is a simplified diagram illustrating a file format of a stripe file according to an embodiment of the present invention;

FIG. 4 is a simplified diagram illustrating a decryption operation according to an embodiment of the present invention;

FIG. 5 is a simplified flow diagram illustrating an encryption process according to an embodiment of the present invention; and

FIG. 6 is a simplified flow diagram illustrating a decryption process according to an embodiment of the present invention.

### DETAILED DESCRIPTION OF THE INVENTION

Various embodiments of the present invention provide techniques for efficiently encrypting and storing data. More specifically, certain embodiments of the present invention allow parallel processing of an input data file by different threads, which substantially improves overall processing speed.

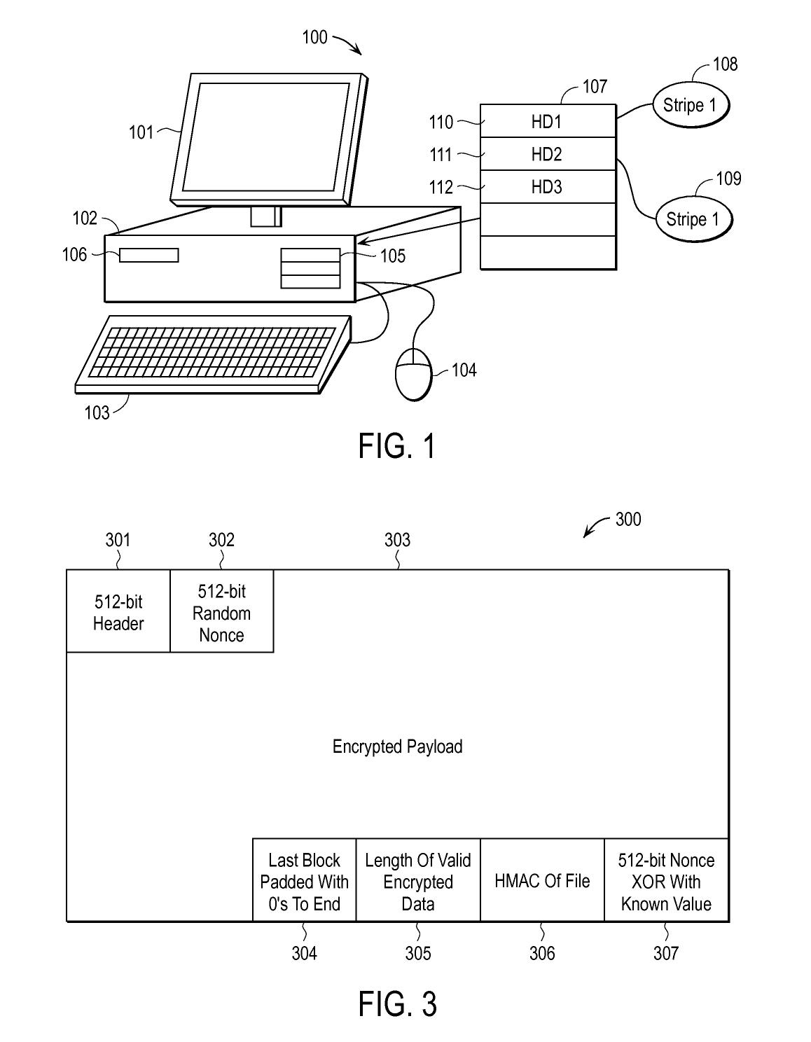

Embodiments of the present invention may be implemented by various types of systems. For example, a specific embodiment of the present invention is implemented with a computer workstation. As another example, an embodiment of the present invention is implemented with a computer server. It is to be understood embodiments of the present invention may be implemented by other types of systems, such as personal computers, etc. FIG. 1 is a simplified diagram illustrating a computer system that is utilized to implement an embodiment of the present invention. This diagram is merely an example, which should not unduly limit the scope of the claims. One of ordinary skill in the art would recognize many variations, alternatives, and modifications.

As shown in FIG. 1, a workstation system 100 includes a display 101, a case 102, a keyboard 103, a mouse 104, and a cluster of hard drives 107. As an example, the workstation system includes one or more central processing units (CPU) and random access memory (RAM) that are encased within the case 102. According to a specific embodiment, the workstation system 100 includes two or more CPUs that are capable of working in parallel. According to another embodiment, the workstation system 100 includes a single CPU that is capable of multitasking and/or interleaving.

The cluster of hard drives 107 is used for storing and backing up data. For example, the cluster of hard drives 107 is arranged as redundant array of independent disks (RAID). As another example, the cluster of hard drives 107 includes hard drives that are independent from one another and accessible to the CPU of workstation system 100. As shown, the hard drives 107 includes a drive 110, a drive 111, and a drive 112, each of the drives being capable of independently storing information. In a specific embodiment, a source file is encrypted and streamed into two or more stripe files. For example, a stripe file 108 is stored by the drive 110 and a stripe file 109 is stored by the drive 111. In a specific embodiment, the hard drives 107 and the system 100 are connected through an interface. Depending on the application, the interface can be SCSI, SATA, fiber channel, USB, IDE, etc.

In an alternative embodiment, the computer system 100 utilizes a single hard drive that is able to simultaneously perform read operation at different portion of the hard drive, thereby allowing multiple accesses.

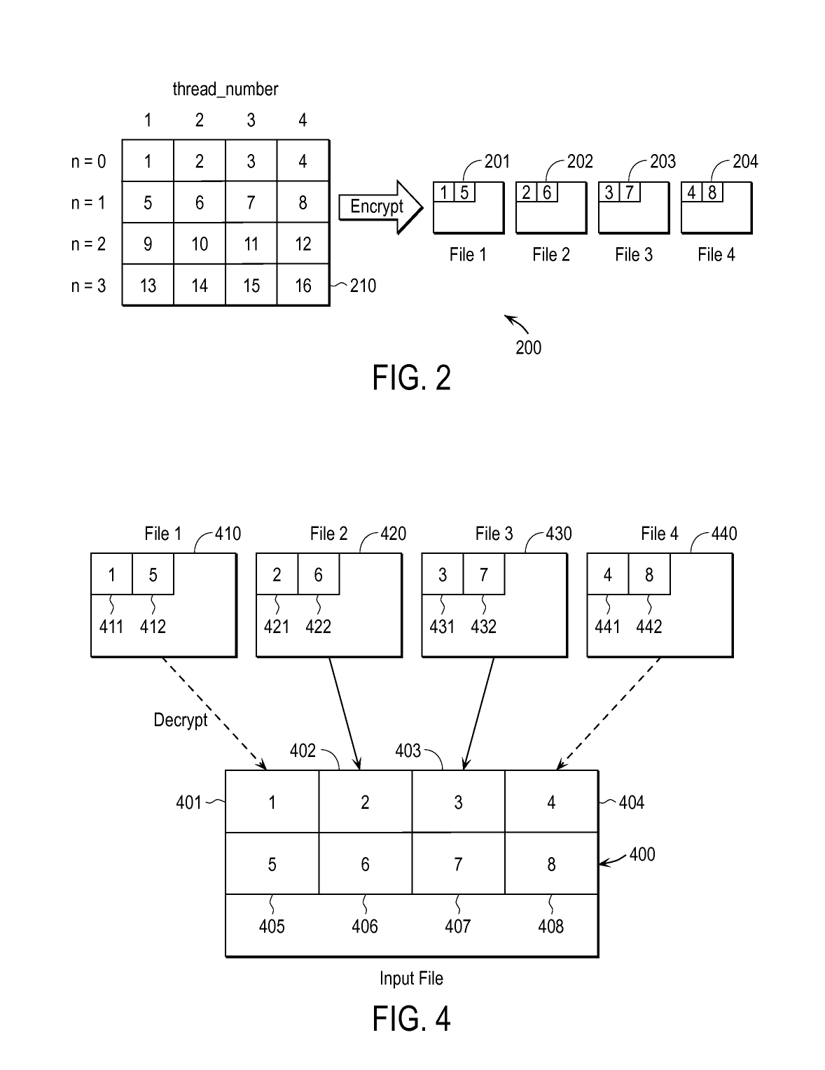

FIG. 2 is a simplified diagram illustrating an encryption operation according to an embodiment of the present invention. In this example, an input file 210 is to be encrypted, and the encrypted files are stored as separate files 201, 202, 203, and 204. As mentioned above, embodiments of present invention are highly flexible and therefore have a wide range of application, but it is to be appreciated that they highly suitable for encrypting and storing large files. For example, in the process of encrypting and storing an input file that is larger than one gigabyte, various embodiments of the present invention are more efficient than conventional techniques due to the possibility of parallel data processing.

The files 201, 202, 203, and 204 can be referred to as stripe files, as striping operations are performed. According to a specific embodiment, each stripe file is processed by a separate thread. Depending upon specific application, the number of stripe files (or referred as stripe width) varies. For example, hardware permitting, a large number (e.g., five or more) of stripe files are generated. In a specific embodiment, the stripe width is determined automatically by a computer based on various factors, such as the number of threads available, the number of processors available, the number of storage devices available, etc. In certain embodiments, the stripe width is user-specified. For example, a user may choose a small number of stripe files for easy file management. As another example, a user may choose a large number of stripe files for better security and/or better performance.

The stripes files are equal sizes. For example, each of the stripe files as shown in FIG. 2 is characterized by the same size, which is generally a little larger (i.e., to account for a header section, etc.) than one quarter of the input file 210. A detailed description of exemplary stripe files is provided below.

It is to be appreciated that embodiments of the present invention provide schemes for threading. Because reading large pieces of data at a time often causes slowing down, embodiments of the present invention provide schemes where each thread reads a small block of data of the input file 210 at a time. As shown in FIG. 2, from the data processing perspective, the input file 210 is divided into a number of blocks. When accessing the input file 210, each thread reads the input file 210 at a specific location for the length for the block size. Merely by way of example, a first thread reads block “1” of the input file 210, encrypts the data stored in block “1”, and stores the encrypted data into a data portion of the stripe file 201. Similarly, a second thread reads block “2” of the input file 210, encrypts the data stored in block “2”, and stores the encrypted data into a data portion of the stripe file 202, and so on.

Depending on the application, various types of encryption methods may be used. In a preferred embodiment, cipher-block chaining (CBC) is used. For example, each block of data is XOR'ed with the previous cipher block (except the first block, which is typically initialized by a data string) before being encrypted. Among other things, each encrypted data is dependent on all previous data blocks up to that point. Usually, CBC encryption allows parallel encryption and decryption.

It is to be understood that present invention is be implemented in conjunction with other types of encryption techniques. In various embodiments, other types of encryption methods are used, such as electronic codebook, initialization vector, cipher feedback, output feedback, etc.

Now referring back to FIG. 2. As shown, the encrypted data blocks stored by each stripe file are non-consecutive. For example, the stripe file 201 stores encrypted data bocks “1” and “5”, which are not continuous data blocks, consecutively.

To be able to achieve desired efficiency from threading, each of threads is configured to process proper data blocks of the input file 210. A preferred embodiment uses the following equation to determine the correct offset location where each thread reads its “n^{th}” block of the input file 210.

Offset=[(stripe_count*block_size)*n]+(thread_number*block_size) (Equation 1)
wherein:
“stripe_count” is the number of strip files being written;
“n” is an integer from zero to [(total blocks infile/stripe count)-1];
“thread_number” is an integer from one to stripe_count (inclusive), typically one thread per strip file; and
“block_size” is the amount data that each threads reads from the input file in a single read operation as well as the amount of data that each thread writes to the stripe file in a single write operation.

The process of reading blocks the input file 210, encrypting the read block, and finally storing encrypted blocks into respective stripe files continues until the entire input file 210 is encrypted and stored.

FIG. 3 is a simplified diagram illustrating a file format of a stripe file 300 according to an embodiment of the present invention. In this embodiment, a stripe file 300 includes the following sections:
1. header section 301;
2. a nonce section 302;
3. a data section 303;
4. a padding section 304;
5. a data length section 305;
6. a MAC section 306; and
7. an XOR nonce section 307.

It is to be understood that the file format of the stripe file 300 merely provides a specific example; stripe files may be formatted to include other sections or fields based on specific implementation. For example, a stripe file according to an embodiment of the present invention is formatted in accordance with the UNIX operating system and has different data sections than those illustrated in FIG. 3. For example, specific data fields may be added or removed so that the stripe file conforms to a UNIX format.

The header section 301 includes information for identifying the file. For example, Table 1 below illustrates an exemplary header section according to certain embodiments of the present invention.

TABLE 1

| Field | Description |
|---|---|
| File identifier | Unique known identifier |
| Version | Version of the file and/or protocol |
| block_size | The I/O size used by threads to read from the |
| | input file and write to the stripe file. |
| File Group GUID | A Globally Unique ID (GUID) that uniquely |
| | identifies a file as a member of a stripe group. |
| Total Number of Files | The number of files in the stripe group. |
| File number and the | This stripe file's position among the stripe |
| total number of files | files making up the original file, as well as the |
| | total number of files. |
| Header HMAC | A keyed Hash Message Authentication Code |
| | (HMAC) used to ensure integrity of header |
| | information. |

Depending upon the application, various fields in the header section 301 may be added, removed, and/or rearranged. For example, the header section 301 may also include a padding field that is filled with zeroes until the end of the header section to ensure that the header block is the same size as the data blocks and other blocks.

The nonce section 302 includes a nonce number and/or a vector. According to an embodiment, the nonce section 302 includes a randomly generated nonce vector that is used as an initializing vector that is used in CBC encryption. The nonce vector is typically different for each stripe file. The utilization of a random nonce vector in various embodiments of the present invention substantially reduces the risk of security breach. In a preferred embodiment, a random nonce vector is generated by using a timestamp. Depending upon the application, the nonce number stored in nonce section 302 may have various lengths and can be generated in various ways.

The data section 303 includes blocks of encrypted data. As described above, depending upon threading and encryption method, the content data blocks stored in data section 303 varies. An encrypted data block may be expressed by the following function:

E{(nonce, payload, pad, length, nonce ⊕ number), key} (Equation 2)

The padding section 304 is provided to ensure that stripe files are equal in length. Since each encrypted data block is equal in length, sometimes it is necessary to fill the last block with padding data. For example, the total data for the stripe file is one byte more than a multiple of five byes, then five five-byte blocks are used to store the input file, and the last block contains one byte of data and four bytes of padding. Usually, the padding involves filling zeroes for remaining space, but it is understood other values or contents may be used for padding.

The data length section 305 stores the information associated with the length of valid data stored in data section 303 not including padding. For example, the data length section 305 includes the number of bytes of encrypted data that are stored in the data section 303. In another example, the data length section 305 itself includes a number of bytes of padding.

The MAC section 306 stores information for authenticating the file. In a specific embodiment, the MAC section 306 includes a key-hash message authentication code (HMAC). For example, an HMAC stored in the MAC section 306 and is determined by using a secret key. Depending upon application, the HMAC may be used verifying data integrity and/or authenticity of the stored data. In a specific embodiment, the HMAC is specified uses the following function:

HMAC{E(header,nonce, payload, pad,length,nonce ⊕ number),key} (Equation 3)

The XOR nonce section 307 includes a special number that is used for encryption and decryption of data. For example, a 512-bit (or 64-byte) random number is exclusive OR'ed with a known value. The random number is the same as the random number stored in the nonce section 302. A special number is calculated for verification purpose using the following equation:

Special_number=nonce ⊕ (nonce ⊕ Special_number) (Equation 4)

As described above, depending on the application, a stripe file may have different fields to suit specific applications. For example, different types of fields may be used if different types of encryption or striping methods are implemented.

According to various embodiments, stripe files are stored separately. For example, stripe files that originate from the same file are stored in different storage devices. When needed, the encrypted stripe files are decrypted and recombined.

FIG. 4 is a simplified diagram illustrating a decryption operation according to an embodiment of the present invention. In this embodiment, four stripe files 410, 420, 430, and 440 are to be decrypted and combined into the output file 400. It is to be appreciated that separate stripe files provide additional security measure, as an unauthorized entity would need all the stripe files before a meaningful segment of decrypted data can be obtained. For example, by decrypting a single stripe file, only noncontiguous blocks of decrypted data are obtained.

As shown in FIG. 4, each of the stripe files includes non-contiguous blocks of data relative to the original file, as stripe files are generated by multiple threads as explained above. As an example, the stripe file 410 includes encrypted data blocks 411 and 412, the stripe file 420 includes encrypted data blocks 421 and 422, the stripe file 430 includes encrypted data blocks 431 and 431, and the stripe file 440 includes encrypted data blocks 441, 442. During an exemplary decryption process, the data blocks 411, 421, 431, and 441 are decrypted by four threads and then stored as data segments 401, 402, 403, and 404 of the output file 400. For example, while data blocks 411, 421, 431, and 441 are respectively stored in four different stripe files, the data segments 401, 402, 403, and 404 are contiguous data segments of the output file 400. As an example, data decryption and output file construction is performed by the workstation system 100 in FIG. 1.

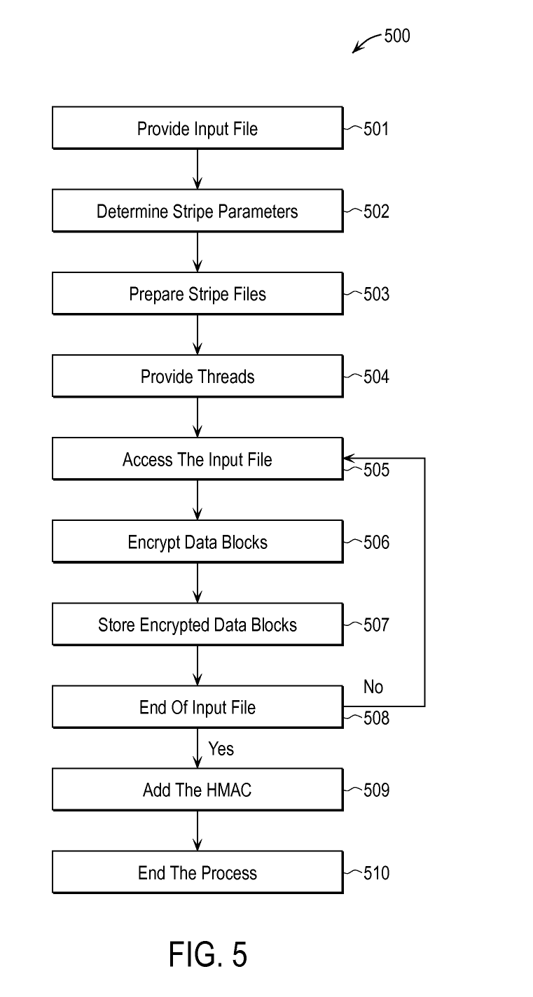

Depending on the specific application, encryption and description processes according to various embodiments of the present invention may be implemented in different ways. As an example, FIG. 5 is a simplified flow diagram illustrating an encryption process 500 according to an embodiment of the present invention. This diagram is merely an example, and various steps in the flow diagram may be added, removed, rearranged, replaced, repeated, overlapped, and/or partially overlapped.

At step 501, an input file that is to be encrypted is provided. As an example, the input file is stored by a hard drive. Typically, the input file has a large size and includes sensitive information, for which efficient data encryption is desired.

At step 502, various parameters for the encryption operation are determined. Depending on the application, these parameters may include the number of output stripe files, block size, encryption method, etc. According to certain embodiments, these parameters are automatically determined based on various factors, such as the size of the input file, the processing power of the system, etc. According to various alternative embodiments, these parameters are provided by the user.

At step 503, stripe files are prepared. Depending upon applications, stripe files may be in accordance with various formats. For example, a stripe file may have the format as illustrated in to FIG. 4.

At step 504, threads are allocated for encrypting the data. According to certain embodiments, the number of threads equals to the stripe width. For example, for a stripe width of four (i.e., four output stripe files to be generated), four threads are provided. Depending upon the application, the number of threads may be smaller or larger.

At step 505, the input file is accessed. According to various embodiments, the input file is accessed by multiple threads in parallel at different segments, each thread reading a block of data at a predetermined location. For example, a first thread reads a block of data from the input file at a first location, and a second threads reads another block of data at a second location, and so on. In a specific embodiment, the input file is stored on a hard disk that provides multiple access. As an example, the offset location as a function of stripe size may be determined using Equation 1.

At step 506, data are encrypted. In a specific embodiment, each data block accessed in step 505 is encrypted by a thread. Depending upon application, various encoding schemes may be employed. For example, a CBC method may be used for encrypting data.

At step 507, encrypted data is stored into the stripe files. In certain embodiments, stripe files are stored in different physical entities (e.g., hard disks). In some embodiments, stripe files are stored on the same physical entity. Merely by way of example, encrypted data blocks are stored into data sections of stripe files.

At branch step 508, whether the input file has been read through is determined. If the entire input file has been encrypted and stored, the process proceeds to step 509. On the other hand, if the input file still contains data yet to encrypted and stored, the process goes back to step 505 to encrypt and store data blocks.

At step 509, a file HMAC of the encrypted data is appended to the stripe files. For example, the file HMAC include information associated with the specific encrypting key and/or method. In certain embodiments, the file HMAC include other information related.

At step 510, the process for encryption and storage ends. According to various embodiments, stripe files are processed accordingly. For example, padding may be added to the end of data sections of the stripe file to make the stripe files uniform in size. In addition, stripe files may be further processed to conform to certain predetermined file formats (e.g., file format as shown in FIG. 4).

The stripe files can later on be decrypted and recombined to create a file that is identical to the input file.

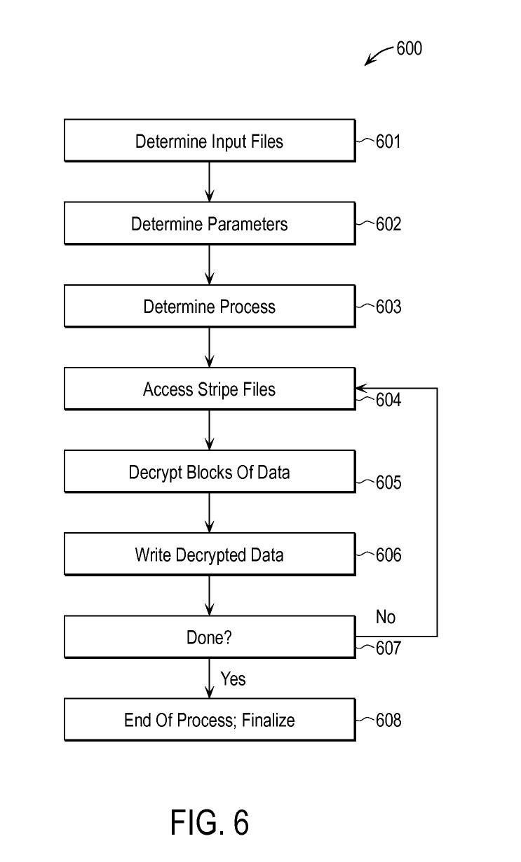

FIG. 6 is a simplified flow diagram illustrating a decryption process 600 according to an embodiment of the present invention. This diagram is merely an example, and various steps in the flow diagram may be added, removed, rearranged, replaced, repeated, overlapped, and/or partially overlapped.

At step 601, stripe files that are needed for decryption are determined. As mentioned above, stripe files that are associated with an input file are selected for decryption. For example, stripe files are collected based on the information stored in the headers of these stripe files. According to certain embodiments, information associated with a set of stripe files is stored in a separate file.

At step 602, various parameters are collected from the stripe files. According to embodiments, parameters, such as stripe width, block size, encryption vector, etc., are extracted from various sections of stripe files. For example, parameters are extracted from the header sections of stripe files.

At step 603, the process for decrypting stripe files is determined. For example, a number of threads is allocated for decrypting stripe files. For example, based on various parameters (e.g., number of threads, block size, decryption key, etc.) collected from stripe files dictate how the decryption process proceeds.

At step 604, stripe files are accessed. According to various embodiments, each of the stripe files is read by a designated thread. For example, each thread reads in parallel a particular block of data from the stripe file.

At step 605, blocks of encrypted data are decrypted. In a preferred embodiment, each block of encrypted data is decrypted by a designated thread.

At step 606, decrypted blocks of data are written onto the output file. As an example, data writing processes are performed by designated threads in parallel for high-speed operation.

At branch step 607, whether the decryption process is complete is determined. For example, once a thread reads end-of-file and/or padding from the stripe file, it is determined that the decryption process is complete. As another example, the decryption process is deemed complete once a predetermined number of blocks have decrypted. If it is determined that the decryption process is complete, the process proceeds to step 608. On the other hand, if it is determined that the decryption process is not complete, the process goes back to step 604.

At step 608, the decryption process is complete. Depending upon application, various measures may be taken to finalize the process. For example, each stripe file is closed.

It is to be appreciated the encryption process and the decryption process as described above may be flexibly implemented in conjunction with different types of hardware system and have broad range of applications.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for encrypting a data file, the method comprising:
providing an input file, the input file being characterized by an input length;
providing a number of output files, the output files including a first output file and a second output file, the first output file being characterized by a first output length, the first output length being associated with the input length and the number of output files, the first output file including a header section and a data section, the header section including information associated with the number;
determining a first location and a second location of the input file, the second location being offset from the first location by a known length;
obtaining a first data segment from reading the input file at the first location by a first thread for the known length;
obtaining a second data segment from reading the input file at the second location by a second thread;
encrypting the first data segment; and
storing the encrypted first data segment at the data section of the first output file.

2. The method of claim 1 further comprising providing a padding section at the end of the data section of the first output file.

3. The method of claim 1 wherein the first output file includes a padding section.

4. The method of claim 1 further comprising:
encrypting the second data segment; and
storing the encrypted second data segment at the second output file.

5. The method of claim 1 wherein the number of output files is determined by a user input.

6. The method of claim 1 wherein the number of output files is associated with a number of available processors.

7. The method of claim 1 wherein the number of output files is associated with a number of usable threads.

8. The method of claim 1 wherein the number of output files is associated with a number of available storage devices.

9. The method of claim 1 wherein:
the input file is stored in a first storage device; and
the first output file is stored in a second storage device.

10. The method of claim 1 wherein the encrypting the first data segment operates under a block cipher mode.

11. The method of claim 1 wherein the encrypting the first data segment comprises cipher-block chaining (CBC).

12. The method of claim 1 wherein:
the first output file is stored in a first storage device; and
the second output file is stored in a second storage device.

13. The method of claim 1 wherein the first output file further comprises a section for storing a message authentication code.

14. The method of claim 1 wherein the header section comprises information associated with the first output length.

15. The method of claim 1 wherein the header section comprises a version number.

16. The method of claim 1 wherein the first output file further comprises a section for storing an identification that is associated with the first output file.

17. The method of claim 1 wherein the first output file further comprises a padding section.

18. The method of claim 1 wherein the first output file further comprises a section for storing a message authentication code that is associated with the encrypting the first data segment.

19. The method of claim 1 wherein the first output file further comprises a nonce section.

20. The method of claim 1 wherein the first output file and the second output file are characterized by equal file lengths.

21. The method of claim 1 wherein the first data segment and the second data segment are characterized by equal file lengths.

22. A method for encrypting a data file, the method comprising:
providing an input file, the input file being characterized by an input length;
providing a number of output files, the output files including a first output file and a second output file, the first output file being characterized by a first output length, the first output length being associated with the input length and the number of output files, the first output file including a first plurality of blocks, the first plurality of blocks including a first block and a second block, the first block and the second block being characterized by the same block size, each of the first plurality of blocks including a header section and a data section, the header section including information with the number;
determining a first location and a second location of the input file, the second location being offset from the first location by a known length;
obtaining a first data segment from reading the input file at the first location by a first thread for the known length;
obtaining a second data segment from reading the input file at the second location by a second thread;
encrypting the first data segment; and
storing the encrypted first data segment at the first block.

23. The method of claim 22 further comprising:
determining a third location, the third location being offset from the second location;
obtaining a third data segment from reading the input file at the third location by the first thread for the known length;
encrypting the third data segment;
storing the encrypted third data segment.

24. A method for decrypting data comprising:
identifying a plurality of input data files, the plurality of input data files including a first input data file and a second input data file, each of input data files being associated with an output data file;
processing the first input data file;
obtaining information associated with the output data file from the first input data file, the information including a block size;
determining two adjacent blocks at the first input data file, the two adjacent blocks including a first block and a second block;
determining two adjacent blocks at the second input data file, the two adjacent blocks including a third block;
obtaining a first data segment by decrypting the first block;
obtaining a second data segment by decrypting the third block; and
storing the first data segment and second data segment in a contiguous portion of the output data file.

25. The method of claim 24 wherein the plurality of data files are characterized by the same length.

26. The method of claim 24 wherein the plurality of data files are stored by different storage devices.

27. The method of claim 24 further comprising obtaining a key for decrypting the first block.

28. The method of claim 24 wherein the method further comprising obtaining a third data segment by decrypting the second block.

29. A system for storing data comprising:
a first storage device, the first storage device being configured to store an input file, the input file including a first section and a second section;
a second storage device, the second storage device being configured to store a plurality of data files, the plurality of data files including a first output file and a second output file, the first output file and the second output file having equal lengths;
a first access component, the first access component being configured to access the first storage device;
a second access component, the second access component being configured to access the first storage device;
a processor component, the processor component being configured to provide a first thread and a second thread;
wherein:
the first access component reads data from the first section;
the first thread generates a first output data by encrypting the first section;
the second access component reads data from the second section;
the second thread generates a second output data by encrypting the second section;
the second storage device stores the first output data at the first output file and the second output data at the second output file.

30. The system of claim 29 wherein the first access component and the first storage device are connected by an interface, the interface being an IDE interface, an SCSI interface, an SATA interface, a USB interface, or a fiber channel.

31. The system of claim 29 wherein the compressor component consists of a processor unit, the processor unit being capable of threading.

32. The system of claim 29 wherein the compressor component includes a plurality of processors, the plurality of processors being configured to operate in parallel.

33. The system of claim 29 wherein:
the second storage devices includes a first hard drive and a second hard drive;
the first output file is stored at the first hard drive;
the second output file is stored at the second hard drive.

34. The system of claim 29 wherein the first thread and the second thread operate in parallel.
